(19) United States
(12) Patent Application Publication
(10) Pub. No.: US 2021/0089862 A1
(43) Pub. Date: Mar. 25, 2021

(54) METHOD AND APPARATUS WITH NEURAL NETWORK DATA PROCESSING AND/OR TRAINING

(71) Applicant: SAMSUNG ELECTRONICS CO., LTD., Suwon-si (KR)

(72) Inventors: Youngsung KIM, Suwon-si (KR); Jaejoon HAN, Seoul (KR)

(73) Assignee: SAMSUNG ELECTRONICS CO., LTD., Suwon-si (KR)

(21) Appl. No.: 17/026,951

(22) Filed: Sep. 21, 2020

Related U.S. Application Data
(60) Provisional application No. 62/903,983, filed on Sep. 23, 2019.

(30) Foreign Application Priority Data
Nov. 21, 2019 (KR) 10-2019-0150527

(51) Int. Cl. G06N 3/04; G06N 3/08; G06K 9/62; G06F 17/16

(52) U.S. Cl. CPC G06N 3/04; G06F 17/16; G06K 9/6257; G06N 3/086

(57) ABSTRACT

A processor-implemented neural network method includes: receiving input data; obtaining a plurality of parameter vectors representing a hierarchical-hyperspherical space comprising a plurality of spheres belonging to a plurality of layers; applying the plurality of parameter vectors to generate a neural network; and generate an inference result by processing the input data using the neural network.

### CROSS-REFERENCE TO RELATED APPLICATIONS

This application claims the benefit under 35 U.S.C. § 119(e) of U.S. Provisional Application No. 62/903,983 filed on Sep. 23, 2019, in the U.S. Patent and Trademark Office, and claims the benefit under 35 U.S.C. § 119(a) of Korean Patent Application No. 10-2019-0150527 filed on Nov. 21, 2019, in the Korean Intellectual Property Office, the entire disclosures of which are incorporated herein by reference for all purposes.

### BACKGROUND

### 1. Field

The following description relates to a method and apparatus with neural network data processing and/or training.

### 2. Description of Related Art

Training data for a neural network (NN) may correspond to a subset of real data. Accordingly, through training of the NN, an output error for input training data may decrease, but an output error for input real data may increase. This increase in the output error for input real data may result from “overfitting,” which refers to a phenomenon in which an error for real data increases by excessively training the NN based on training data. That is, due to overfitting, an error of the NN may increase.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a processor-implemented neural network method includes: receiving input data; obtaining a plurality of parameter vectors representing a hierarchical-hyperspherical space comprising a plurality of spheres belonging to a plurality of layers; applying the plurality of parameter vectors to generate a neural network; and generating an inference result by processing the input data using the neural network.

The neural network may include a convolutional neural network (CNN), and the plurality of parameter vectors may include a plurality of filter parameter vectors.

The input data may include image data.

The receiving of the input data may include capturing the input data, and the generating of the inference result may include performing recognition of the input data.

The plurality of layers may correspond to different hierarchical levels in the hierarchical-hyperspherical space.

Centers of spheres, of the plurality of spheres, belonging to a same layer, of the plurality of layers, in the hierarchical-hyperspherical space may be determined based on a center of a sphere belonging to an upper layer of the same layer.

A radius of a sphere, of the plurality of spheres, belonging to a predetermined layer, of the plurality of layers, in the hierarchical-hyperspherical space may be less than a radius of a sphere belonging to an upper layer of the predetermined layer.

A center of a sphere, of the plurality of spheres, belonging to a predetermined layer, of the plurality of layers, in the hierarchical-hyperspherical space may be located in a sphere belonging to an upper layer of the predetermined layer.

Spheres belonging to a same layer, of the plurality of layers, in the hierarchical-hyperspherical space may not overlap one another.

A distribution of the plurality of parameter vectors may be greater than a threshold distribution, and the distribution of the plurality of parameter vectors may indicate a degree by which the plurality of parameter vectors may be globally and uniformly distributed in the hierarchical-hyperspherical space.

The distribution of the plurality of parameter vectors may be determined based on a combination of a discrete distance between the plurality of parameter vectors and a continuous distance between the plurality of parameter vectors.

The discrete distance may be determined by quantizing the plurality of parameter vectors and calculating a hamming distance between the quantized parameter vectors.

The continuous distance may include an angular distance between the plurality of parameter vectors.

Each of the plurality of parameter vectors may include a center vector indicating a center of a corresponding sphere and a surface vector indicating a surface of the corresponding sphere.

The applying of the plurality of parameter vectors to the neural network may include, for each of the plurality of parameter vectors: generating a projection vector based on the center vector and the surface vector; and applying the projection vector to the neural network.

The generating of the inference result by processing the input data using the neural network may include performing hyperspherical convolutions based on the input data and the generated projection vectors.

The input data may be training data, and the method may include: determining a loss term based on a label of the training data and a result of the processing of the training data; determining a regularization term; and training the plurality of parameter vectors based on the loss term and the regularization term.

In another general aspect, a processor-implemented neural network method includes: receiving training data; processing the training data using a neural network; determining a loss term based on a label of the training data and a result of the processing of the training data; determining a regularization term such that a plurality of parameter vectors of the neural network represent a hierarchical-hyperspherical space comprising a plurality of spheres belonging to a plurality of layers; and training the plurality of parameter vectors based on the loss term and the regularization term, to generate an updated neural network.

The neural network may include a convolutional neural network (CNN), the plurality of parameter vectors may include a plurality of filter parameter vectors, and the training data may include image data.

Centers of spheres, of the plurality of spheres, belonging to a same layer, of the plurality of layers, in the hierarchical-hyperspherical space may be determined based on a center of a sphere belonging to an upper layer of the same layer.

The regularization term may be determined based on any one or any combination of: a first constraint condition in which a radius of a sphere, of the plurality of spheres, belonging to a predetermined layer, of the plurality of layers, in the hierarchical-hyperspherical space is less than a radius of a sphere belonging to an upper layer of the predetermined layer; a second constraint condition in which a center of the sphere belonging to the predetermined layer is located in the sphere belonging to the upper layer of the predetermined layer; and a third constraint condition in which spheres belonging to a same layer in the hierarchical-hyperspherical space do not overlap one another.

The regularization term may be determined such that a distribution of the plurality of parameter vectors may be greater than a threshold distribution, and the distribution of the plurality of parameter vectors may indicate a degree by which the plurality of parameter vectors may be globally and uniformly distributed in the hierarchical-hyperspherical space.

The distribution of the plurality of parameter vectors may be determined based on a combination of a discrete distance between the plurality of parameter vectors and a continuous distance between the plurality of parameter vectors.

The discrete distance may be determined by quantizing the plurality of parameter vectors and calculating a hamming distance between the quantized parameter vectors; and the continuous distance may include an angular distance between the plurality of parameter vectors.

Each of the plurality of parameter vectors may include a center vector indicating a center of a corresponding sphere and a surface vector indicating a surface of the corresponding sphere.

The regularization term may be determined based on any one or any combination of: a first distance term based on a distance between center vectors of spheres, of the plurality of spheres, belonging to a same layer, of the plurality of layers, in the hierarchical spherical space; a second distance term based on a distance between surface vectors of the spheres belonging to the same layer in the hierarchical spherical space; a third distance term based on a distance between center vectors of spheres, of the plurality of spheres, belonging to different layers, of the plurality of layers, in the hierarchical spherical space; and a fourth distance term based on a distance between surface vectors of the spheres belonging to the different layers in the hierarchical spherical space.

A non-transitory computer-readable storage medium may store instructions that, when executed by a processor, configure the processor to perform the method.

In another general aspect, a neural network apparatus may include: a communication interface configured to receive input data; a memory storing a plurality of parameter vectors representing a hierarchical-hyperspherical space comprising a plurality of spheres belonging to a plurality of layers; and a processor configured to apply the plurality of parameter vectors to generate a neural network and to generate an inference result by a configured implementation of a processing of the input data using the generated neural network.

The apparatus may include an image sensor configured to interact with the communication interface to provide the received input data, wherein the communication interface may be configured to receive from an outside the parameter vectors and store the parameter vectors in the memory.

The apparatus may include instructions that, when executed by the processor, configure the processor to implement the communication interface to receive the input data, and to implement the neural network to generate the inference result.

Other features and aspects will be apparent from the following detailed description, the drawings, and the claims.

### BRIEF DESCRIPTION OF THE DRAWINGS

FIGS. 1A through 1D illustrate hierarchical-hyperspherical spaces according to one or more embodiments.

FIGS. 2, 3A, and 3B illustrate methods of calculating a distance metric to maximize a pairwise distance in a spherical space according to one or more embodiments.

FIG. 4 illustrates a structure of a network to which a hierarchical regularization is applied according to one or more embodiments.

FIG. 5 illustrates a network to calculate a hierarchical parameter vector according to one or more embodiments.

FIG. 6 illustrates a generator to generate an image through a generation of a layered noise vector according to one or more embodiments.

FIG. 7 is a flowchart illustrating a method of processing data using a neural network according to one or more embodiments.

FIG. 8 is a flowchart illustrating a neural network training method according to one or more embodiments.

FIG. 9 is a block diagram illustrating a data processing apparatus for processing data using a neural network according to one or more embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The following structural or functional descriptions of examples disclosed in the present disclosure are merely intended for the purpose of describing the examples and the examples may be implemented in various forms. The examples are not meant to be limited, but it is intended that various modifications, equivalents, and alternatives are also covered within the scope of the claims.

Although terms of “first” or “second” are used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween. Likewise, similar expressions, for example, “between” and “immediately between,” and “adjacent to” and “immediately adjacent to,” are also to be construed in the same way. As used herein, the term “and/or” includes any one and any combination of any two or more of the associated listed items.

As used herein, the singular forms are intended to include the plural forms as well, unless the context clearly indicates otherwise. The terminology used herein is for describing various examples only and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment (e.g., as to what an example or embodiment may include or implement) means that at least one example or embodiment exists where such a feature is included or implemented, while all examples are not limited thereto.

Hereinafter, examples will be described in detail with reference to the accompanying drawings, and like reference numerals in the drawings refer to like elements throughout.

To solve the technological problem of overfitting, one or more embodiments of the present disclosure may train a neural network using a regularization numerical analysis technique to advantageously decrease an output error for input real data.

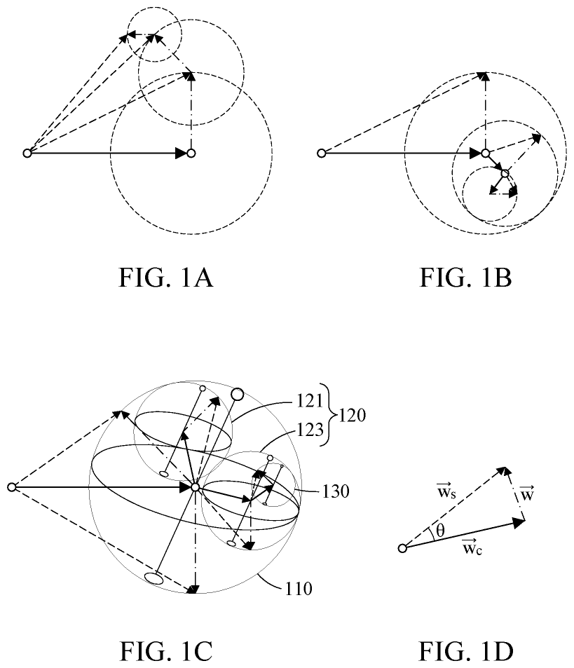

FIGS. 1A through 1D illustrate hierarchical-hyperspherical spaces according to one or more embodiments. A hypersphere is a set of points at a constant distance from a given point called “centre.” The hypersphere is a manifold of codimension one, that is, with one dimension less than that of an ambient space. As a radius of the hypersphere increases, a curvature of the hypersphere decreases. In a limit, a surface of a hypersphere approaches a zero curvature of a hyperplane. Hyperplanes and hyperspheres are examples of hypersurfaces.

In an example, a group between parameter vectors for samples with the same or sufficiently similar characteristic may be formed and a regularization may be applied to the group. In an example, the samples may include input images and the parameter vectors may include filter parameter vectors (or weight parameter vectors) of a filter (or kernel) of a convolutional neural network (CNN). In this example, a class for defining each group may be referred to as a “super-class.” For each sample of a class, a pair of coarse super-classes and coarse sub-classes and a pair of fine super-classes and fine sub-classes may be defined, to form a layer of a hyperspherical space.

Since it is typically difficult to measure a pairwise distance between high dimensional vectors with a hierarchical structure in the same space, one or more embodiments of the present disclosure may construct another identification space [symbol] including a space isolated from the original space.

Here, the d-sphere [symbol] refers to a set of points satisfying [symbol] ={w∈ [symbol] :∥w∥=1}, for example.

Multiple separated hyperspheres may be constructed using multiple identifying relationships. In an example, a single space may be decomposed into multiple spaces, and redefined in terms of a hierarchical point of view, and accordingly a hierarchical structure may be applied to a regularization of a parameter vector of a hyperspherical space for each of multiple groups. To uniformly distribute parameter vectors on a unit hypersphere, the parameter vectors may be sampled from a Gaussian normal distribution. This is because the Gaussian normal distribution is spherically symmetric. Also, in a Bayesian point of view, a neural network with a Gaussian prior may induce an L2-norm regularization.

Based on the above description, a parameter vector of the neural network for the hyperspherical space may be trained to have a Gaussian prior. A projection vector calculated by a difference arithmetic operation between two parameter vectors in the Gaussian normal distribution may indicate a normal difference distribution.

In a deep neural network, an objective function [symbol] with a regularization [symbol] in addition to a loss [symbol] , [symbol] _{(W)}= [symbol] (x,W)+ [symbol] (W), may optimize a parameter tensor W near a minimum loss [symbol] , arg min_{W} [symbol] _{(x,W)} in which x∈ [symbol] denotes an input vector. The parameter tensor may be a multi-dimensional matrix and may include a matrix or a vector, as non-limiting examples.

The term “parameter vector” used herein may be a parameter tensor or a parameter matrix, depending on examples.

W={Wᵢ∈ [symbol] :Wᵢ={wⱼ∈ [symbol] }, j=1, . . . , cᵢ, i=1, . . . , L} denotes metrics (for example, neuron connective weights or kernels) of a parameter vector, L denotes a number of layers, and λ>0 is to control a degree of a regularization, for example.

For example, for a classification task, a cross entropy loss may be used for the loss function [symbol] .

In an example, a regularization may be performed using a new regularization formulation [symbol] .

w, an element of W at a single layer, denotes a projection vector to transform a given input into an embedding space defined in a Euclidean metric space x∈ [symbol] [symbol] w^{T}x∈ [symbol] , for example.

By defining a unit-length projection w/∥w∥, a new parameter vector ŵ may be defined on the d-sphere [symbol] ={ŵ∈ [symbol] :∥ŵ∥=1} in which ∥⋅∥ denotes l²-norm and a center is zero. In other words, a projection vector ŵ may be defined by a center vector w_{c}∈ [symbol] indicating a center of a hypersphere and a surface vector wₛ∈ [symbol] that uses an arithmetic operation ŵ:=wₛ−w_{c}, for example.

In an example, a d-sphere [symbol] ={wₛ−w_{c}∈ [symbol] :∥wₛ−w_{c}∥=1} may be defined by the center vector w_{c} and the surface vector wₛ. Hereinafter, for a simplicity of a notation, w is used instead of ŵ.

In an example, when a radius is regarded to be “1”, a parameter vector has a radius r >0.

FIG. 1A illustrates hierarchical spherical spaces constructed based on center vectors in each spherical space of a hyperspherical space according to one or more embodiments.

A radius of a global area converges to

$$\frac{{r}_{0}}{1 - δ}$$

when a level l goes to infinity.

$$\frac{{r}_{0}}{1 - δ} = {Σ}_{l}^{∞} {r}_{0} {δ}^{l}$$

denotes a sum of radius series, and δ denotes a constant.

Also, r₀ denotes an initial radius of a sphere, and the constant δ is a ratio between radiuses

$$\frac{{r}_{l}}{{r}_{l} - 1}$$

of which an absolute value is less than “1”.

FIG. 1B illustrates non-overlapping spheres included in a hyperspherical space according to one or more embodiments. A radius of a global area may be bounded to an initial radius r₀ of a hypersphere, which may be similar to a process of repeating hypersphere packing that arranges non-overlapping spheres containing a space.

FIG. 1C illustrates a hierarchical-hyperspherical space modeled in a bounded space according to one or more embodiments. Following FIG. 1B, a hierarchical 2-sphere may be defined and generalized to a higher dimensional sphere, that is, a hypersphere.

In an example, a parameter vector may be trained such that a diversity increases using a parameter vector such as a projection matrix or a projection vector as a transformation of an input vector. For example, a diversity of parameter vectors may be increased by a regularization through a globally uniform distribution between the parameter vectors. To this end, semantics between parameter vectors may be applied through a hierarchical space, and a distribution between high-dimensional parameter vectors may be diversified based on a distance metric in the same semantic space (for example, spheres belonging to the same layer in a single group) and a different semantic space (for example, spheres belonging to different layers).

In FIG. 10, a sphere 110 may correspond to, for example, a sphere of a first layer, and spheres 121 and 123 correspond to, for example, spheres of a second layer. The spheres 121 and 123 belonging to the same layer may correspond to a single group 120. A sphere 130 may correspond to, for example, a sphere of a third layer. Centers of spheres (for example, the spheres 121 and 123) belonging to the same layer in a hierarchical-hyperspherical space of FIG. 1C may be determined based on a center of a sphere (for example, the sphere 110) belonging to an upper layer of the same layer.

FIG. 1D illustrates a center vector, a surface vector \vec{w}_{c} and \vec{w}ₛ a projection vector \vec{w} according to one or more embodiments. The projection vector \vec{w} is determined based on a difference between the surface vector \vec{w}ₛ and the center vector \vec{w}_{c} as shown in \vec{w}=\vec{w}ₛ−\vec{w}_{c}, and a magnitude of projection vector \vec{w} may be adjustable, for example. Also,

$${\vec{w}}^{′} = \frac{\vec{w}}{‖ \vec{w} ‖} δ$$

is satisfied, and \vec{w}″ may exist in multiples of δ. The projection vector \vec{w}, the surface vector \vec{w}ₛ and the center vector \vec{w}_{c} may respectively correspond to the above-described vectors ŵ, wₛ and w_{c}, for example.

For example, a hierarchical structure of a hypersphere may include a levelwise structure with a notation (l) and a groupwise structure with a notation g.

Levelwise Structure

Parameter vectors for [symbol] may be defined by a levelwise notation (l) as shown in Equation 1 below, for example.

w^{(l)}:=wₛ^{(l)}−w_{c}^{(l)} Equation 1:

In Equation 1, the parameter vectors are defined as [symbol] for an l-level of a d-th sphere.

For example, hierarchical parameter vectors are defined in a higher dimensional space than those of FIGS. 1B and 10.

In a levelwise setting, wₛ^{(l)} and w_{c}^{(l)} may be represented as w_{c}^{(l-1)}+\vec{Δw}^{(l)} [symbol] w_{c}^{(l)} based on a center vector calculated in a previous level.

$${w}_{c}^{( l - 1 )} = {Σ}_{i}^{l - 1} {\vec{Δ w}}^{( i )}$$

denotes an accumulated center vector, and [symbol] denotes a parameter vector newly connected from w_{c}^{(l-1)} to w_{c}^{(l)}.

By denoting \vec{Δw}^{(l)} as w^{(l,l-1)}, a center vector at an l-level may be defined as w_{c}^{(l)}:=w_{c}^{(l,l-1)}+w_{c}^{(l-1)} and a surface vector may be defined as wₛ^{(l)}:=wₛ^{(l,l-1)}+w_{c}^{(l-1)}.

Both a center vector and a surface vector at a current level may be based on a center vector at a previous level. However, since all samples do not include a child sample, it may be more advantageous to perform branching from a representative parameter or a center parameter rather than from an individual projection vector.

A level may correspond to each layer in a hierarchical structure. In the following description, the terms “level” and “layer” are understood to have the same meaning.

Equation 1 described above is expressed by Equation 2 shown below, for example.

w^{(l)}=wₛ^{(l,l-1)}−w_{c}^{(l,l-1)} Equation 2:

For example, using (l,l−1), a vector connected from a center vector at an (l−1)-th level to an (l)-th level is denoted.

Groupwise Structure

By a group notation gₖ, the center vector in Equation 1 may be expressed as w_{c,g}_{ₖ}^{(l,l-1)} on a d-sphere

$${𝕊}_{{w}_{c , {g}_{k}}^{( l , l - 1 )}}^{d}$$

of gₖ group at the l-th level.

$${g}^{( l )} \text{:=} {\{ {g}_{k} \}}_{k = 1}^{\vert {g}^{( l )} \vert} , {g}^{( l )} ⊆ {𝔾}^{( l )}$$

denotes a group set at the l-th level, and |⋅| denotes a cardinality.

A group g^{(l)} at the current level may be adjusted in a group of a previous level

$${g}^{( l - 1 )} \text{:=} {\{ {g}_{{k}^{′}} \}}_{{k}^{′} = 1}^{\vert {g}^{( l - 1 )} \vert}$$

in which g^{(l-)}⊆ [symbol] ^{(l-1)}.

With a groupwise relationship for levels, an adjacency indication

$${P}^{( l , l - 1 )} ( \{ {𝔾}^{( l - 1 )} , {𝔾}^{( l )} \} ) ∈ {\{ 0 , 1 \}}^{\vert {𝔾}^{( l - 1 )} \vert \times \vert {𝔾}^{( l )} \vert}$$

may be calculated. Depending on examples, the adjacency indication may be replaced with a probability model. Thus, a projection vector at the l-th level may be determined as

$${w}_{{g}_{k} , i}^{( l )} \text{:=} \{ {w}_{s , {g}_{k} , i}^{( l , l - 1 )} - {w}_{c , {g}_{k}}^{( l , l - 1 )} \} on {𝕊}_{{w}_{c}^{( l , l - 1 )} , {g}_{k}}^{d}$$

in which i=1, . . . , |gₖ|.

Also, {w_{s,g}_{ₖ}^{(l,l-1)},w_{c,g}_{ₖ}^{(l,l-1)}} may be calculated based on w_{c,g}_{^{(l−1)}}^{(l-1)} referring to their group condition and an adjacency matrix P^{(l,l-1)}.

A representative vector of the group gₖ at the (l) level is w_{c,g}_{ₖ}^{(l)}, and the representative vector w_{c,g}_{ₖ}^{(l)} is equal to a mean vector of

$${w}_{s , {g}_{k}}^{( l )} ⇒ μ ( {w}_{s , {g}_{k}}^{( l )} ) = \frac{1}{\vert {g}_{k} \vert} {Σ}^{\vert {g}_{k} \vert} {w}_{s , {g}_{k}}^{( l )} .$$

When the representative vector of the group gₖ is determined by a predetermined vector and the center vector at the previous level, an adjustment factor ϵ may be used as w_{c,g}_{ₖ}^{(l,l-1)}=w_{c,g}_{_{k′}}^{(l-1)}+ϵ·w_{g}_{_{k′}}_{,i}^{(l-1)} in which

$${w}_{{g}_{{k}^{′}} , i}^{( l - 1 )} ∈ {𝕊}_{{w}_{c , {g}_{k}^{′}}^{( l - 1 )}}^{d} .$$

In an example, parameter vectors for each layer may be defined based on a center vector in a spherical space, which may be suitable for training for each group. For example, a regularization may be performed by defining a center and/or a radius of each of spheres included in a hierarchical-hyperspherical space and by assigning a constraint condition to a space for each group.

A regularization term of a hierarchical parameter vector defined above is defined below.

A set of parameter vectors {W_{s,g}_{ₖ}^{(l,l-1)},w_{c,g}_{ₖ}^{(l,l-1)},w_{c,g′}_{ₖ}^{(l-1)}}∈W∀gₖ, ∀gₖ in which W_{s,g}_{ₖ}^{(l,l-1)}:={w_{s,g}_{ₖ}_{,i}^{(l,l-1)}}ᵢ₌₁^{|g}^{ₖ}^{|}, is an optimization target of a hierarchical regularization as shown in Equation 3 below, for example.

$$ℛ ( W ) \text{:=} {\sum }_{I} {λ}_{l} {ℛ}_{l} ( {W}_{s , {g}_{k}}^{( l , l - 1 )} , {w}_{c , {g}_{k}}^{( l , l - 1 )} ; {P}^{( l , l - 1 )} ) + {\sum }_{I} {𝒞}_{l} ( {w}_{c , {g}_{k}}^{( l , l - 1 )} , {w}_{c , {g}_{k}^{′}}^{( l - 1 )} ; {P}^{( l , l - 1 )} )$$

In Equation 3, [symbol] operates on an individual sphere

$${𝕊}_{{w}_{c , {g}_{k}}^{( l , l - 1 )}}^{d} ,$$

λₗ∈ [symbol] _{>0}, and [symbol] ₗ denotes a constraint term to apply geometry-aware constraints to a sphere. For example, the constraint term [symbol] ₗ may correspond to a constraint on a relationship between spheres which indicates how the relationship between spheres is to be formed.

Equation 3 may be used for a regularization between an upper layer and a lower layer.

[symbol] includes two regularization terms as shown in Equation 4 below:

a term [symbol] _{l,p} for projection vectors in the same group gₖ of

$${𝕊}_{{w}_{c , {g}_{k}}^{( l , l - 1 )}}^{d} ;$$

and

a term [symbol] _{l,c} for center vectors across groups at the same level of

$${𝕊}_{{w}_{c , {g}_{k}^{′}}^{( l - 1 )}}^{d} ,$$

for example.

[symbol]

ₗ(W_{s,g}_{ₖ}^{(l,l-1)},w_{c,g}_{ₖ}^{(l,l-1)}:= [symbol] _{l,p}(W_{s,g}_{ₖ}^{(l,l-1)},w_{c,g}_{ₖ}^{(l,l-1)}+ [symbol] _{l,c}(w_{c,g}_{ₖ}^{(l,l-1)}) Equation 4:

In Equation 4, [symbol] _{l,p} is a regularization term of a distance between projection vectors and may be expressed as shown in Equation 5 below, for example. Also, [symbol] _{l,c} is a regularization term of a distance between center vectors and may be expressed as shown in Equation 6 below, for example.

$${ℛ}_{l , p} ( {W}_{s , {g}_{k}}^{( l , l - 1 )} , {w}_{c , {g}_{k}}^{( l , l - 1 )} ) \text{:=} \frac{1}{\vert {g}^{( l )} \vert} \frac{2}{G ( G - 1 )} {\sum }_{\{ {g}_{k} ∈ {g}^{( l )} \}} {\sum }_{\{ i \neq j ∈ {g}_{k} \}} d ( {w}_{{g}_{k} , i}^{( l , l - 1 )} , {w}_{{g}_{k} , j}^{( l , l - 1 )} ) \qquad Equation 5$$

$${ℛ}_{l , c} ( {w}_{c , {g}_{k}}^{( l , l - 1 )} ) \text{:=} \frac{2}{C ( C - 1 )} {\sum }_{M} d ( {w}_{c , {g}_{i}}^{( l , l - 1 )} , {w}_{c , {g}_{j}}^{( l , l - 1 )} ) \qquad Equation 6$$

In Equation 5 and 6, w_{g}_{ₖ}_{,i}^{(l,l-1)}:=w_{s,g}_{ₖ}_{,i}^{(l,l-1)}−w_{c,g}_{ₖ}^{(l,l-1)}. Also, G=|{i≠j∈gₖ}|, and C=|{gᵢ≠gⱼ∈g^{(l)}}|. d(⋅,⋅) denotes a distance metric between parameter vectors.

For example, when a mini batch is given, the regularization term may be

$$E ( ℛ ( W ) ) = \frac{1}{\vert {m}_{x} \vert} {Σ}_{{m}_{x}} ℛ ( W ; {m}_{x} ) .$$

In addition to the above hierarchical regularization of Equation 3, an orthogonality promoting term may be applied to a center vector

$${w}_{c , {g}_{k}}^{( l , l - 1 )} \text{:} arg {min}_{{W}_{c}^{( l , l - 1 )}} {λ}_{o} {‖ {W}_{c}^{{( l , l - 1 )}^{T}} {W}_{c}^{( l , l - 1 )} - I ‖}_{F} .$$

In

$${w}_{c , {g}_{k}}^{( l , l - 1 )} \text{:} arg {min}_{{W}_{c}^{( l , l - 1 )}} {λ}_{o} {‖ {W}_{c}^{{( l , l - 1 )}^{T}} {W}_{c}^{( l , l - 1 )} - I ‖}_{F} , {W}_{c}^{( l , l - 1 )} ∈ {ℝ}^{d \times \vert {g}_{k} \vert} , {‖ \cdot ‖}_{F}$$

denotes a Frobenius norm, and λₒ>0.

For example, a magnitude (l²-norm) minimization and energy minimization may be applied to parameter vectors that do not have hierarchical information. In this example, the magnitude minimization may be performed by arg min_{w} λ_{f}Σₖ∥wₖ∥ in which wₖ∈W and λ_{f}>0. The energy minimization may be performed by arg min_{w} Σ_{i≠j}λ_{c}d(wᵢ,wⱼ) in which λ_{c}>0. The energy minimization may be referred to as a “pairwise distance minimization”.

The constraint term [symbol] ₗ described in the right side of Equation 3 helps in constructing geometry-aware relational parameter vectors between different spheres.

Multiple constraint conditions are defined as [symbol] ₗ:=Σₖλₖ [symbol] _{l,k} in which [symbol] _{l,k} denotes a k-th constraint condition between parameter vectors at the l-th level and (l−1)-th level, and λ_{>0} denotes a Lagrange multiplier.

For example, three constraint conditions may be applied in a geometric point of view. The three constraint conditions are defined below.

1. Constraint condition 1 C₁: describes that a radius of an l-th inner sphere is less than a radius of an (l−1)-th outer sphere as shown in the following equation:

r^{(l-1)}−r^{(l)}≥0⇒∥w^{(l-1)}−w^{(l)}∥=∥wₛ^{(l-1)}−w_{c}^{(l-1)}∥−∥wₛ^{(l)}−w_{c}^{(l)}∥≥0.

2. Constraint condition 2 C₂: describes that a center of an l-th inner sphere is located in an (l−1)-th outer sphere as shown in the following equation:

r^{(l-1)}−(∥w_{c}^{(l,l-1)}∥+r^{(l)}≥0⇒r^{(l-1)}−(∥w_{c}^{(l-1,0)}−w_{c}^{(l,0)}∥+r^{(l)})=∥wₛ^{(l-1,0)}−w_{c}^{(l-1)}∥−(∥w_{c}^{(l-1)}−w_{c}^{(l)}∥+∥wₛ^{(l)}−w_{c}^{(l)}∥)≥0.

3. Constraint condition 3 C₃: describes that a margin between spheres is greater than zero as shown in the following equation:

$$‖ {w}_{c}^{( l , l - 1 )} ‖ {( 2 - 2 cos θ )}^{0.5} - 2 {r}^{( l )} \geq 0 ⇒ ‖ {w}_{c}^{( l )} ‖ {( 2 - 2 \frac{{Σ}_{i \neq j} {w}_{c}^{( l ) , i} \cdot {w}_{c}^{( l ) , j}}{{‖ {w}_{c}^{( l )} ‖}^{2}} )}^{0.5} - 2 ‖ {w}_{s}^{( l )} - {w}_{c}^{( l )} ‖ , where ‖ {w}_{c}^{( l , l - 1 )} ‖ {( 2 - 2 cos θ )}^{0.5} = ‖ {w}_{c}^{( l , l - 1 )} ‖ {( {r}^{( l - 1 )} sin {θ}^{2} - {( {r}^{( l - 1 )} - {r}^{( l - 1 )} cos θ )}^{2} )}^{0.5} .$$

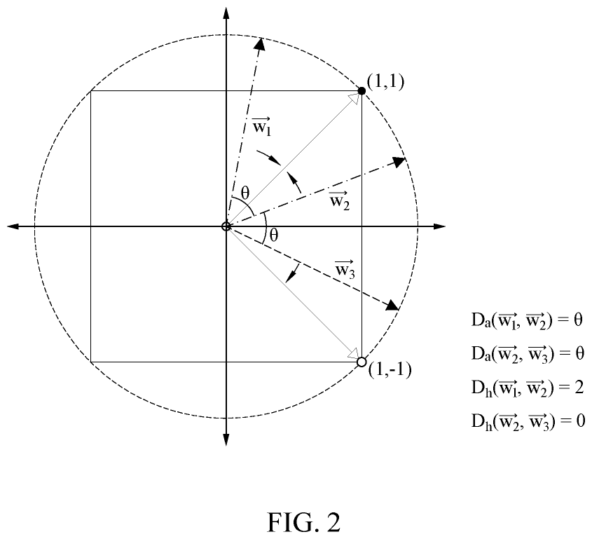

FIG. 2 illustrates a method of calculating a distance metric to maximize a pairwise distance in a spherical space according to one or more embodiments. FIG. 2 illustrates an angular distance Dₐ between a pair of vectors {w₁,w₂}, an angular distance Dₐ between a pair of vectors {w₂,w₃}, a discrete distance Dₕ between the pair of vectors {w₁,w₂} and a discrete distance Dₕ between the pair of vectors {w₂,w₃}.

A discrete product metric may be suitable for the above-described groupwise definition, and projection points from parameter vectors formed in a discrete metric space may be isolated from each other.

The discrete distance may be determined such that a pair of vectors with the same angular distance are distributed. To maximize a distance between parameter vectors, maximization of the discrete distance may variously distribute the parameter vectors.

In FIG. 2, the angular distances Dₐ are identical to each other, but the discrete distances Dₕ are different from each other. To diversify a parameter vector space, a space with signs is effective in recognizing a difference.

When a sign function is used in a Euclidean metric space [symbol] , a discrete distance metric for vectors wᵢ and wⱼ may be defined as shown in Equation 7 below, for example.

$${D}_{h} \text{:=} \frac{1}{d} {\sum }_{k}^{d} sign ( {w}_{i} ( k ) ) \cdot sign ( {w}_{j} ( k ) ) \qquad Equation 7$$

In Equation 7,

$$sign ( x ) \text{:=} \{ \begin{matrix}1 , & if x \geq 0 \\ - 1 , & otherwise\end{matrix} , - 1 \leq {D}_{h} \leq 1 , and w = \{ w ( k ) \vert ∀ k = 1 , … , d \} ∈ {ℝ}^{d + 1} \} . sign ( x )$$

denotes a normalized version of a hamming distance. For a ternary discrete, {−1,0,1} may be used for sign(x).

For example, to regard the discrete distance as an angular distance within [0, 1], a normalized distance may be defined as

$${D}_{h 01} \text{:=} \frac{- {D}_{h} + 1}{2} , 0 \leq {D}_{h 01} \leq 1.$$

An angular distance based on a product is expressed as θ_{D}_{ₕ}=Dₕ₀₁, and 0≤θ_{D}_{ₕ}≤1 may be satisfied. However, an angle is regarded as Dₕ:=cos θ_{D}_{ₕ}π for a cosine similarity. Accordingly, to obtain an angular distance, an arccosine function

$${θ}_{{D}_{h}} = \frac{1}{π} arccos {D}_{h}$$

may be used. In other words, for the angular distance θ_{D}_{ₕ}, Dₕ₀₁ or

$${D}_{h 01}^{′} = \frac{1}{π} arccos {D}_{h}$$

may be applied, and 0≤Dₕ₀₁≤1 may be satisfied.

The discrete distance may be limited to approximate a model distribution.

A discrete distance metric may be merged with a continuous angular distance metric

$$( θ = \frac{1}{π} arccos ( \frac{{w}_{i} \cdot {w}_{j}}{‖ {w}_{i} ‖ ‖ {w}_{j} ‖} ) , 0 \leq θ \leq 1 )$$

into a single metric.

For example, a definition of Pythagorean means including an arithmetic mean (AM), a geometric mean (GM) and a harmonic mean (HM) may be used to merge the discrete distance metric with the continuous angular distance metric.

Pythagorean means using the above-described angle pair may be defined as shown in Equation 8 below, for example.

$${D}_{AM} \text{:=} \frac{{θ}_{{D}_{h}} + θ}{2} , {D}_{GM} \text{:=} {θ}_{{D}_{h}} θ , {D}_{HM} \text{:=} \frac{4 {θ}_{{D}_{h}} θ}{{θ}_{{D}_{h}} + θ} \qquad Equation 8$$

In an angular distance using {θ_{D}_{ₕ},θ}, a reversed form

$$1 - {D}_{\{ {θ}_{{D}_{h}} , θ \}}$$

may be adopted to maximize an angle in an optimization formulation as a form of minimization instead of (⋅)^{-s}. In 0≤θ≤1, an angle and its cosine value show an inverse relationship, for example, 0≤θ≤1→1≥cos θπ≤−1. Here, s=1, 2, . . . is used in a Thomson problem that utilizes s-energy.

A cosine similarity of the above angles may be defined as shown in Equation 9 below, for example.

$${D}_{cos ( AM )} \text{:=} cos ( \frac{{θ}_{{D}_{h}} + θ}{2} π ) , {D}_{cos ( GM )} \text{:=} cos ( {θ}_{{D}_{h}} θπ ) , {D}_{cos ( HM )} \text{:=} cos ( \frac{4 {θ}_{{D}_{h}} θ}{{θ}_{{D}_{h}} + θ} π ) \qquad Equation 9$$

In Equation 9, cosine similarity functions may be normalized with

$$\frac{cos ( \cdot ) + 1}{2}$$

to have a distance value within [0,1].

Pythagorean means of a cosine similarity may be calculated as shown in Equation 10 below, for example.

$${D}_{{AM}_{cos}} \text{:=} \frac{cos {θ}_{{D}_{h}} π + cos θπ + 2}{4} , {D}_{{GM}_{cos}} \text{:=} \frac{( cos {θ}_{{D}_{h}} π + 1 ) ( cos θπ + 1 )}{4} , {D}_{{HM}_{cos}} \text{:=} \frac{( cos {θ}_{{D}_{h}} π + 1 ) ( cos θπ + 1 )}{cos {θ}_{{D}_{h}} + cos θ + 2} . \qquad Equation 10$$

Metrics defined in Equations 8, 9 and 10 satisfy three metric conditions, that is, non-negativity, symmetry and triangle inequality.

A distance using the above-described metrics between two points may be limited, because a hypersphere is a compact manifold.

Since a sign function is not differentiable at a value of “0”, a backpropagation function instead of the sign function may be used. For a sign function in a discrete metric, a straight-through estimator (STE) may be adopted in a backward path of a neural network.

A derivative of the sign function is substituted with 1_{|w|≤1} that is known as a saturated STE in the backward path.

A derivative of

$$arccos ( x ) ( \frac{- 1}{\sqrt{1 - {x}^{2}}} )$$

is not defined at a value of x=±1, and accordingly x∈[−0.99,0.99] may be obtained by applying clamping to a cosine function. Also, x=cos(θπ), 0≤θ≤1 may be satisfied.

FIGS. 3A and 3B illustrate results obtained by mapping a continuous value to a discrete value in an Euclidean space according to one or more embodiments. FIG. 3A illustrates a result obtained by mapping a ternary representation in a two-dimensional (2D) space to a predetermined representation of all points within each quadrant. FIG. 3B illustrates a result obtained by expressing a distance between discretized vectors by a discrete value within a bound.

When a dimensionality of a vector increases, a probability of increasing a sparsity of the vector may also increase. A Euclidean distance may be (|x−y|\hat{ }2=|x|\hat{ }2+|y|\hat{ }2−2x·y). When two parameter vectors are similar, for example, (x·y≈0), there is a technological problem in that it may be difficult to reflect a similarity between the two parameter vectors due to magnitude values (|x|\hat{ }2+|y|\hat{ }2) of the two parameter vectors.

Since a cosine distance is calculated after a parameter vector is projected to a unit sphere (|x−y|2=2−2x·y), a noise effect may decrease. However, since a search space increases when searching for parameter vectors with an even distribution in a spherical space, there is a technological problem in that an optimization may not be achieved. Thus, one or more embodiments of the present disclosure may solve such technological problem and achieve optimization by using a distance space obtained by reducing the search space.

In one or more embodiments of the present disclosure, a continuous value in a Euclidean space may be mapped to, for example, a binary or ternary discrete value, and thus a uniform parameter vector distribution may be stably trained.

In one or more embodiments of the present disclosure, when a parameter vector is searched for in a discretized space as shown in FIGS. 3A and 3B, a number of cases in which parameter vectors are redundant may be reduced, and a process of obtaining a solution may be optimized. However, since power of expression may be weakened when a space is narrower than a required space according to circumstances, one or more embodiments of the present disclosure may have a stronger power of expression by a combination with a continuous metric of a sufficient space. To this end, one or more embodiments of the present disclosure may merge a continuous angular distance metric and a discrete distance metric such as a cosine distance or an arccosine distance using Equations 8 through 10 described above, thereby have a stronger power of expression.

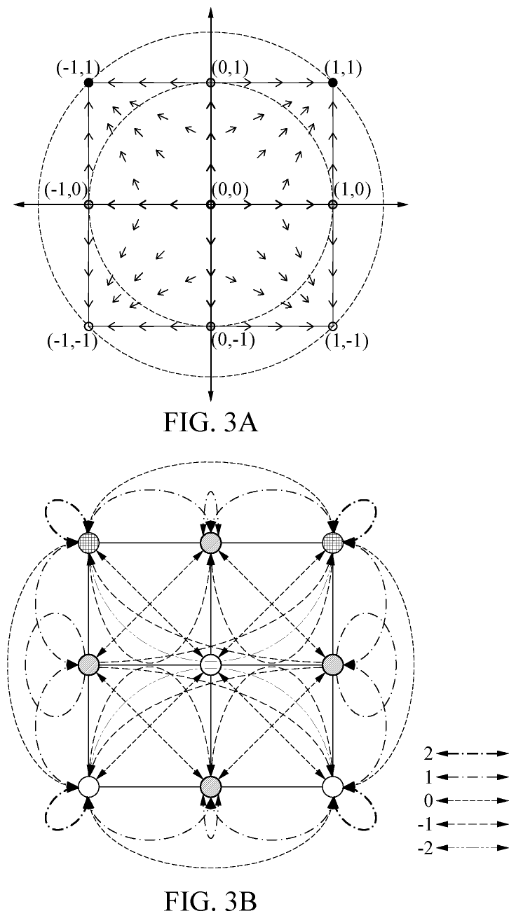

FIG. 4 illustrates a structure of a network to which a hierarchical regularization is applied according to one or more embodiments. The network of FIG. 4 may include an encoder 410, a coarse segmenter 420, a fine classifier 430, a relationship regularizer 440, and an optimizer 450.

The encoder 410 may extract a feature vector of input data.

The coarse segmenter 420 may output a coarse label of the feature vector through a loss function L and a regularization function R. The coarse segmenter 420 may perform a regularization between an upper level and a lower level by Equation 3 described above, and the coarse label may correspond to the above-described center vector, for example.

The fine classifier 430 may output a fine label of the feature vector through the loss function L and the regularization function R. The fine classifier 430 may perform a regularization between same levels by Equation 4 described above, and the fine label may correspond to the above-described surface vector, for example.

The relationship regularizer 440 may perform a regularization by a relationship between the coarse label and the fine label. A regularization result by a relationship R_{(c,f)} of the relationship regularizer 440 may correspond to [symbol] ₗ of Equation 3, and a constraint on a relationship between spheres which indicates how the relationship between spheres is to be formed.

For example, a regularization may be expressed as R=R_{f}+R_{(c,f)}+(R_{c}), which corresponds to Equations 3 and 4, for example.

A label at every layer in a hierarchical structure may be trained by the relationship R_{(c,f)} between the coarse label and the fine label, and a regularization at the last layer may be performed by R_{f}.

A regularization may be performed by maximizing a distance (for example,

$${Σ}_{n} {Σ}_{i \neq j} d ( {\vec{w}}_{i}^{n} , {\vec{w}}_{j}^{n} ) )$$

between parameter vectors, or by minimizing energy between parameter vectors.

A regularization reflecting hierarchical information may also be performed by a regularization of a representative parameter vector for each group reflecting statistical characteristics (for example, a mean) of parameter vectors for each group.

A label of R_{(c,f)} representing a relationship may be obtained through clustering of self-supervised learning or semi-supervised learning. A hierarchical parameter vector (obtained by combining a coarse parameter vector corresponding to the coarse label and a fine parameter vector corresponding to the fine label) may be applied to a neural network and input data may be processed using the neural network to which the hierarchical parameter vector is applied.

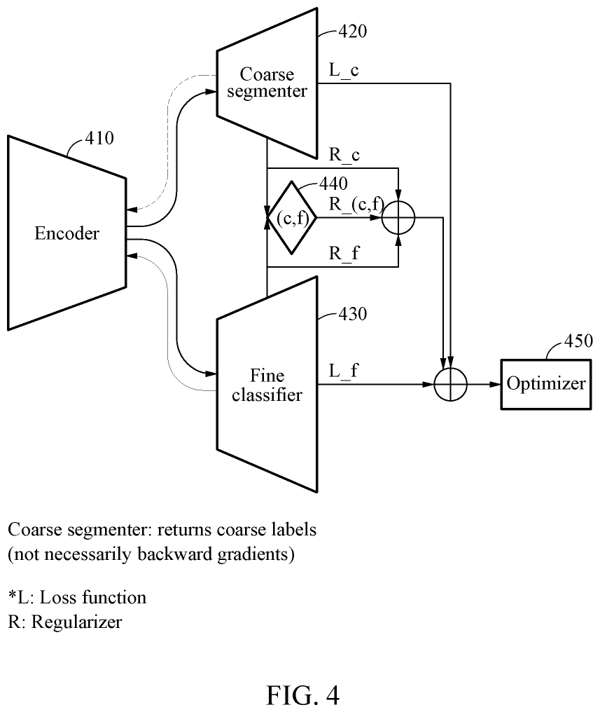

FIG. 5 illustrates a network to calculate a hierarchical parameter vector according to one or more embodiments. FIG. 5 illustrates an input image 510, a coarse parameter vector 520, a fine parameter vector 530, a hierarchical parameter vector 540, and a feature 550.

The input image 510 may be represented by the coarse parameter vector 520 and the fine parameter vector 530 through a hierarchical-hyperspherical space that includes a plurality of spheres belonging to different layers. The hierarchical parameter vector 540 (obtained by combining the coarse parameter vector 520 and the fine parameter vector 530) may be applied to a neural network, and input data (e.g. the input image 510) may be processed, and accordingly the feature 550 corresponding to the input image 510 may be output. For example, the feature 550 may be generated by performing a convolution operation based on the input image 510 (or a feature vector generated based on the input image 510), using the neural network to which the hierarchical parameter vector 540 is applied.

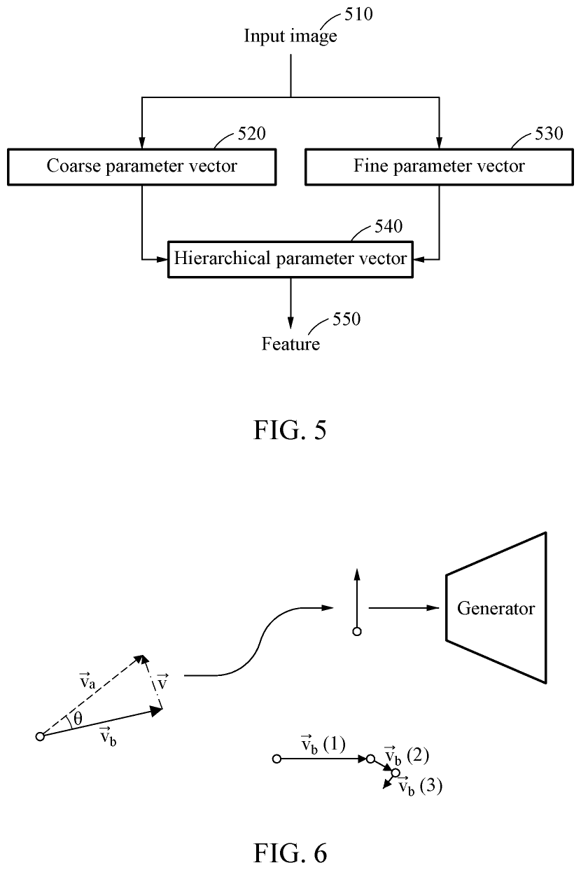

FIG. 6 illustrates a generator configured to generate an image through a generation of a layered noise vector according to one or more embodiments.

The generator may form, or represent, a multilayer neural network. Also, a recognizer or a generator in a layered representation may be generated by a combination of the above-described coarse parameter vector and fine parameter vector.

$${\vec{v}}_{b}^{( 1 ) , k} ∼ N ( μ , {σ}^{2} ) , {min}_{{\vec{v}}_{b}^{( 1 ) , k}} R ( {\vec{v}}_{b}^{( 1 ) , k} , \cdot ) ∀ k$$

$${\vec{v}}_{b}^{( 2 )} ∼ N ( μ , {σ}^{2} ) , \frac{{\vec{v}}_{b}^{( 2 )}}{‖ {\vec{v}}_{b}^{( 2 )} ‖} = {\vec{v}}_{b}^{{( 1 )}^{T}} \cdot ‖ {\vec{v}}_{b}^{( 1 )} ‖ cos θ$$

The generator, configured to generate an image, may be utilized through the generation of the layered noise vector.

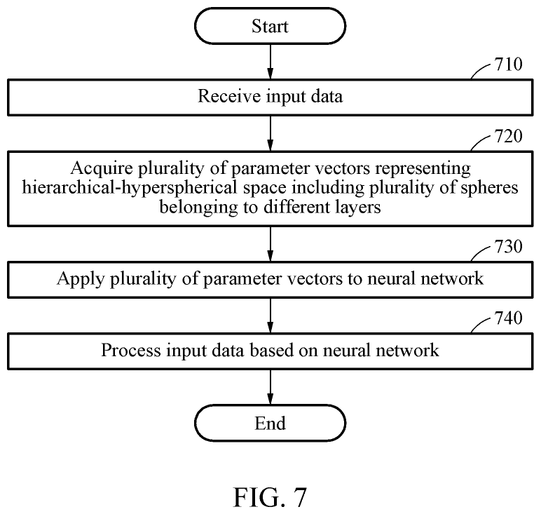

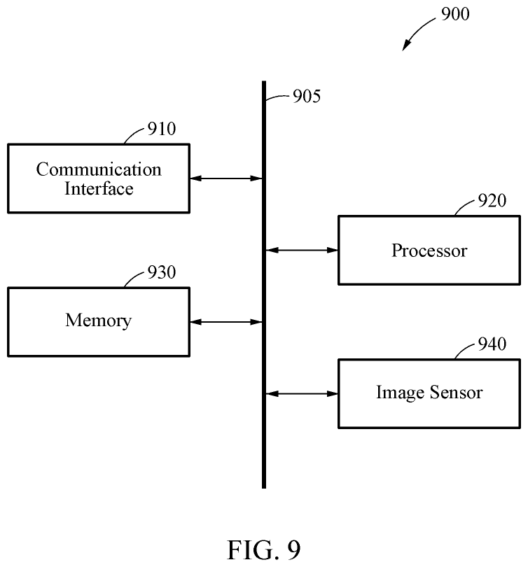

FIG. 7 is a flowchart illustrating a method of processing data using a neural network according to one or more embodiments. Referring to FIG. 7, in operation 710, a data processing apparatus may receive, obtain, or capture input data using an image sensor (e.g., the image sensor 940 of FIG. 9, discussed below). The input data may include, for example, image data.

In operation 720, the data processing apparatus may acquire or obtain (e.g., from a memory) a plurality of parameter vectors representing a hierarchical-hyperspherical space that includes a plurality of spheres belonging to different layers. The plurality of parameter vectors may correspond to, for example, the above-described projection vector w or a projection parameter vector. Each of the plurality of parameter vectors may include a center vector w_{c} indicating a center of a corresponding sphere and a surface vector wₛ indicating a surface of the surface.

Centers of spheres belonging to the same layer in the hierarchical-hyperspherical space may be determined based on, for example, a center of a sphere belonging to an upper layer of the same layer. For example, both a center vector and a surface vector at a current level may be based on a center vector at a previous level. The hierarchical-hyperspherical space may satisfy constraint conditions described below. A radius of a sphere belonging to a predetermined layer in the hierarchical-hyperspherical space may be less than a radius of a sphere belonging to an upper layer of the predetermined layer. A center of a sphere belonging to a predetermined layer may be located in the sphere belonging to an upper layer of the predetermined layer, and spheres belonging to the same layer in the hierarchical-hyperspherical space may not overlap each other.

A distribution of the plurality of parameter vectors, which indicates a degree by which the plurality of parameter vectors are globally and uniformly distributed in the hierarchical-hyperspherical space, may be greater than a threshold distribution. The distribution may be determined based on, for example, a combination of a discrete distance between the plurality of parameter vectors and a continuous distance between the plurality of parameter vectors. The discrete distance may be determined by quantizing the plurality of parameter vectors and calculating a hamming distance between the quantized parameter vectors. The discrete distance may correspond to, for example, the discrete distance Dₕ of FIG. 2.

The continuous distance may include an angular distance between the plurality of parameter vectors. The continuous distance may correspond to, for example, the angular distance Dₐ of FIG. 2.

In operation 730, the data processing apparatus may apply the plurality of parameter vectors to generate the neural network. The neural network may include, for example, a convolutional neural network (CNN), and the plurality of parameter vectors may include a plurality of filter parameter vectors. For example, the data processing apparatus may generate a projection vector based on a center vector and a surface vector corresponding to each of the plurality of parameter vectors, and may apply the projection vector to generate the neural network. In this example, the center vector and the surface vector may correspond to a center vector and a surface vector of a sphere belonging to a level or layer of one of the plurality of spheres included in the hierarchical-hyperspherical space. For example, when a current level is l, a center vector indicating a center of a sphere with the level l may correspond to the above-described w_{c}^{(l)}, and a surface vector indicating a surface of the sphere with the level l may correspond to the above-described wₛ^{(l)}.

In operation 740, the data processing apparatus may process the input data based on the generated neural network to which the plurality of parameter vectors are applied in operation 730. In an example, the processing of the input data using the generated neural network may include performing recognition of the input data.

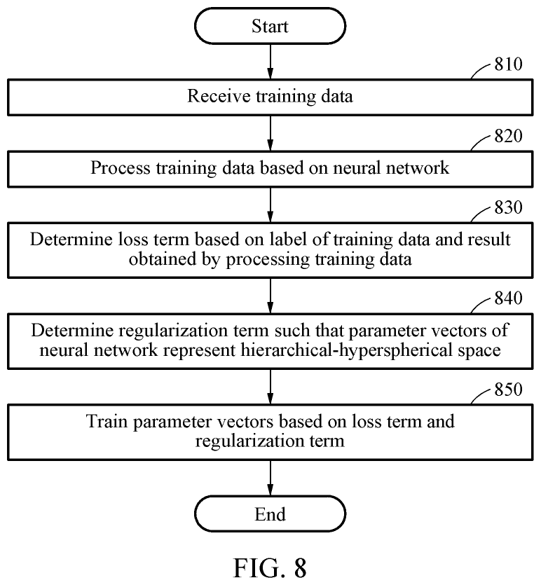

FIG. 8 is a flowchart illustrating a neural network training method according to one or more embodiments. Referring to FIG. 8, in operation 810, a training apparatus may receive training data. The training data may include, for example, image data.

In operation 820, the training apparatus may process the training data based on a neural network. The neural network may include, for example, a CNN, and a plurality of parameter vectors of the neural network may include a plurality of filter parameter vectors. Each of the plurality of parameter vectors may include a center vector indicating a center of a corresponding sphere and a surface vector indicating a surface of the sphere.

In operation 830, the training apparatus may determine a loss term, for example, [symbol] , based on a label of the training data and a result obtained by processing the training data.

In operation 840, the training apparatus may determine a regularization term, for example, [symbol] , such that the parameter vectors of the neural network represent a hierarchical-hyperspherical space. The hierarchical-hyperspherical space may include a plurality of spheres belonging to different layers. Also, centers of spheres belonging to the same layer in the hierarchical-hyperspherical space may be determined based on a center of a sphere belonging to an upper layer of the same layer. In operation 840, the regularization term may be determined based on any one or any combination of a first constraint condition in which a radius of a sphere belonging to a predetermined layer in the hierarchical-hyperspherical space is less than a radius of a sphere belonging to an upper layer of the predetermined layer, a second constraint condition in which a center of a sphere belonging to a predetermined layer is located in a sphere belonging to an upper layer of the predetermined layer, and a third constraint condition in which spheres belonging to the same layer in the hierarchical-hyperspherical space do not overlap each other.

For example, the regularization term may be determined such that a distribution of the plurality of parameter vectors is greater than a threshold distribution. The distribution may indicate a degree by which the plurality of parameter vectors are globally and uniformly distributed in the hierarchical-hyperspherical space, that is, indicates a degree A of a regularization. The distribution may be determined based on, for example, a combination of a discrete distance between the plurality of parameter vectors and a continuous distance between the plurality of parameter vectors. The discrete distance may be determined by quantizing the plurality of parameter vectors and calculating a hamming distance between the quantized parameter vectors. The continuous distance may include an angular distance between the plurality of parameter vectors.

Also, the regularization term may be determined based on, for example, any one or any combination of a first distance term based on a distance between center vectors of spheres belonging to the same layer in the hierarchical spherical space, a second distance term based on a distance between surface vectors of spheres belonging to the same layer in the hierarchical spherical space, a third distance term based on a distance between center vectors of spheres belonging to different layers in the hierarchical spherical space, and a fourth distance term based on a distance between surface vectors of spheres belonging to different layers in the hierarchical spherical space.

In operation 850, the training apparatus may train the parameter vectors based on the loss term determined in operation 830 and the regularization term determined in operation 840.

FIG. 9 is a block diagram illustrating a data processing apparatus (e.g., data processing apparatus 900) for processing data based on a neural network according to one or more embodiments. Referring to FIG. 9, the data processing apparatus 900 may include a communication interface 910 and a processor 920 (e.g., one or more processors). The data processing apparatus 900 may further include a memory 930 (e.g., one or more memories) and an image sensor 940 (e.g., on or more image sensors). The communication interface 910, the processor 920, the memory 930, and the image sensor 940 may communicate with each other via a communication bus 905.

The communication interface 910 may receive input data. The communication interface 910 may receive the input data from the image sensor 940. The image sensor 940 may acquire or capture the input data when the input data is image data. The image sensor 940 may be an optic sensor such as a camera. The communication interface 910 may acquire a plurality of parameter vectors representing a hierarchical-hyperspherical space that includes a plurality of spheres belonging to different layers.

The processor 920 may apply the plurality of parameter vectors to a neural network and processes the input data based on the neural network.

Also, the processor 920 may perform at least one of the methods described above with reference to FIGS. 1 through 8 or an algorithm corresponding to at least one of the methods described above with reference to FIGS. 1-8. The processor 920 is a hardware-implemented data processing device having a circuit that is physically structured to execute desired operations. For example, the desired operations may include code or instructions included in a program. The hardware-implemented data processing device may include, for example, a microprocessor, a central processing unit (CPU), a processor core, a multi-core processor, a multiprocessor, an application-specific integrated circuit (ASIC), and a field-programmable gate array (FPGA).

The processor 920 may execute a program and control the data processing apparatus 900. Codes of the program executed by the processor 920 may be stored in the memory 930.

The memory 930 may store a variety of information generated in a processing process of the above-described processor 920. Also, the memory 930 may store a variety of data and programs. The memory 930 may include, for example, a volatile memory or a non-volatile memory. The memory 930 may include a high-capacity storage medium such as a hard disk to store a variety of data.

The apparatuses, units, modules, devices, encoders, course segmenters, fine classifiers, relationship regularizers, optimizers, generators, data processing apparatuses, communication buses, communication interfaces, processors, memories, image sensors, encoder 410, course segmenter 420, fine classifier 430, relationship regularizer 440, optimizer 450, generator, data processing apparatus 900, communication bus 905, communication interface 910, processor 920, memory 930, image sensor 940, and other components described herein with respect to FIGS. 1-9 are implemented by or representative of hardware components. Examples of hardware components that may be used to perform the operations described in this application where appropriate include controllers, sensors, generators, drivers, memories, comparators, arithmetic logic modules, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic module, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-9 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions used herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A processor-implemented neural network method comprising:
receiving input data;
obtaining a plurality of parameter vectors representing a hierarchical-hyperspherical space comprising a plurality of spheres belonging to a plurality of layers;
applying the plurality of parameter vectors to generate a neural network; and
generating an inference result by processing the input data using the neural network.

2. The method of claim 1, wherein
the neural network comprises a convolutional neural network (CNN), and
the plurality of parameter vectors comprise a plurality of filter parameter vectors.

3. The method of claim 1, wherein the input data comprises image data.

4. The method of claim 1, wherein
the receiving of the input data includes capturing the input data, and
the generating of the inference result comprises performing recognition of the input data.

5. The method of claim 1, wherein the plurality of layers correspond to different hierarchical levels in the hierarchical-hyperspherical space.

6. The method of claim 1, wherein centers of spheres, of the plurality of spheres, belonging to a same layer, of the plurality of layers, in the hierarchical-hyperspherical space are determined based on a center of a sphere belonging to an upper layer of the same layer.

7. The method of claim 1, wherein a radius of a sphere, of the plurality of spheres, belonging to a predetermined layer, of the plurality of layers, in the hierarchical-hyperspherical space is less than a radius of a sphere belonging to an upper layer of the predetermined layer.

8. The method of claim 1, wherein a center of a sphere, of the plurality of spheres, belonging to a predetermined layer, of the plurality of layers, in the hierarchical-hyperspherical space is located in a sphere belonging to an upper layer of the predetermined layer.

9. The method of claim 1, wherein spheres belonging to a same layer, of the plurality of layers, in the hierarchical-hyperspherical space do not overlap one another.

10. The method of claim 1, wherein
a distribution of the plurality of parameter vectors is greater than a threshold distribution, and
the distribution of the plurality of parameter vectors indicates a degree by which the plurality of parameter vectors are globally and uniformly distributed in the hierarchical-hyperspherical space.

11. The method of claim 10, wherein the distribution of the plurality of parameter vectors is determined based on a combination of a discrete distance between the plurality of parameter vectors and a continuous distance between the plurality of parameter vectors.

12. The method of claim 11, wherein the discrete distance is determined by quantizing the plurality of parameter vectors and calculating a hamming distance between the quantized parameter vectors.

13. The method of claim 11, wherein the continuous distance comprises an angular distance between the plurality of parameter vectors.

14. The method of claim 1, wherein each of the plurality of parameter vectors comprises a center vector indicating a center of a corresponding sphere and a surface vector indicating a surface of the corresponding sphere.

15. The method of claim 14, wherein the applying of the plurality of parameter vectors to the neural network comprises, for each of the plurality of parameter vectors:
generating a projection vector based on the center vector and the surface vector; and
applying the projection vector to the neural network.

16. The method of claim 15, wherein the generating of the inference result by processing the input data using the neural network comprises performing hyperspherical convolutions based on the input data and the generated projection vectors.

17. A processor-implemented neural network method comprising:
receiving training data;
processing the training data using a neural network;
determining a loss term based on a label of the training data and a result of the processing of the training data;
determining a regularization term such that a plurality of parameter vectors of the neural network represent a hierarchical-hyperspherical space comprising a plurality of spheres belonging to a plurality of layers; and
training the plurality of parameter vectors based on the loss term and the regularization term, to generate an updated neural network.

18. The method of claim 17, wherein
the neural network comprises a convolutional neural network (CNN),
the plurality of parameter vectors comprise a plurality of filter parameter vectors, and
the training data comprises image data.

19. The method of claim 17, wherein centers of spheres, of the plurality of spheres, belonging to a same layer, of the plurality of layers, in the hierarchical-hyperspherical space are determined based on a center of a sphere belonging to an upper layer of the same layer.

20. The method of claim 17, wherein the regularization term is determined based on any one or any combination of:
a first constraint condition in which a radius of a sphere, of the plurality of spheres, belonging to a predetermined layer, of the plurality of layers, in the hierarchical-hyperspherical space is less than a radius of a sphere belonging to an upper layer of the predetermined layer;
a second constraint condition in which a center of the sphere belonging to the predetermined layer is located in the sphere belonging to the upper layer of the predetermined layer; and
a third constraint condition in which spheres belonging to a same layer in the hierarchical-hyperspherical space do not overlap one another.

21. The method of claim 17, wherein
the regularization term is determined such that a distribution of the plurality of parameter vectors is greater than a threshold distribution, and
the distribution of the plurality of parameter vectors indicates a degree by which the plurality of parameter vectors are globally and uniformly distributed in the hierarchical-hyperspherical space.

22. The method of claim 21, wherein the distribution of the plurality of parameter vectors is determined based on a combination of a discrete distance between the plurality of parameter vectors and a continuous distance between the plurality of parameter vectors.

23. The method of claim 22, wherein
the discrete distance is determined by quantizing the plurality of parameter vectors and calculating a hamming distance between the quantized parameter vectors; and
the continuous distance comprises an angular distance between the plurality of parameter vectors.

24. The method of claim 17, wherein each of the plurality of parameter vectors comprises a center vector indicating a center of a corresponding sphere and a surface vector indicating a surface of the corresponding sphere.

25. The method of claim 17, wherein the regularization term is determined based on any one or any combination of:
a first distance term based on a distance between center vectors of spheres, of the plurality of spheres, belonging to a same layer, of the plurality of layers, in the hierarchical spherical space;
a second distance term based on a distance between surface vectors of the spheres belonging to the same layer in the hierarchical spherical space;
a third distance term based on a distance between center vectors of spheres, of the plurality of spheres, belonging to different layers, of the plurality of layers, in the hierarchical spherical space; and
a fourth distance term based on a distance between surface vectors of the spheres belonging to the different layers in the hierarchical spherical space.

26. A non-transitory computer-readable storage medium storing instructions that, when executed by a processor, configure the processor to perform the method of claim 17.

27. A neural network apparatus comprising:
a communication interface configured to receive input data;
a memory storing a plurality of parameter vectors representing a hierarchical-hyperspherical space comprising a plurality of spheres belonging to a plurality of layers; and
a processor configured to apply the plurality of parameter vectors to generate a neural network and to generate an inference result by a configured implementation of a processing of the input data using the generated neural network.

28. The apparatus of claim 27, further comprising an image sensor configured to interact with the communication interface to provide the received input data, wherein the communication interface is configured to receive from an outside the parameter vectors and store the parameter vectors in the memory.

29. The apparatus of claim 27, further comprising instructions that, when executed by the processor, configure the processor to implement the communication interface to receive the input data, and to implement the neural network to generate the inference result.
